(19) United States
(12) Patent Application Publication
(10) Pub. No.: US 2026/0335922 A1
(43) Pub. Date: Oct. 29, 2026

(54) CONTROL DEVICE FOR A MULTIPLE NOZZLE HOLDER

(71) Applicant: EXEL INDUSTRIES, EPERNAY (FR)

(72) Inventor: Sylvain PITAUD, CHANEINS (FR)

(73) Assignee: EXEL INDUSTRIES, EPERNAY (FR)

(21) Appl. No.: 19/655,309

(22) Filed: Apr. 22, 2026

(30) Foreign Application Priority Data
Apr. 24, 2025 (FR) 2504348

(51) Int. Cl. B05B 15/65; A01G 25/16; B05B 15/70

(52) U.S. Cl. CPC B05B 15/65; A01G 25/16; B05B 15/70

(57) ABSTRACT

A control device for controlling at least one nozzle holder, the device having an electric motor housed in a housing of the control device for driving a transmission element in rotation to transmit the rotational movement to an actuator of the nozzle holder; at least one power cable configured to supply electrical energy to the electric motor via an electronic board of the control device, the electronic board being housed in the housing; an orientation sensor connected to the electronic board and being configured to determine an angular orientation of the transmission element of the electric motor; and wherein the device is configured to control the rotation of the actuator of the nozzle holder so as to activate at least one given spray nozzle of the nozzle holder.

### CROSS-REFERENCE TO RELATED APPLICATION

This regular U.S. utility application claims the benefit of FR 2504348, filed on Apr. 24, 2024, the contents of which are expressly incorporated herein by reference.

### TECHNICAL FIELD

The present invention relates to the field of agricultural spraying.

In particular, the invention relates to a motorization system for a multiple nozzle holder of an agricultural spraying system.

### BACKGROUND

An agricultural spray boom is generally comprised of nozzle holders distributed uniformly over the entire length of the spray boom, for spraying a plant protection product in liquid form onto rows of plants. To improve the efficiency of spraying the product, it is necessary to vary the spray flow rate of the nozzles and to control it proportionally to the forward speed of the agricultural machine carrying the spray boom and/or depending on the product sprayed, for example. To address this issue, nozzle holders supporting several nozzles are known, such as different nozzles or nozzles that have different flow rates.

When a user wishes to change a nozzle, they must perform a generally manual operation to rotate the nozzle holder and thus activate another nozzle suitable for a different forward speed of the agricultural machine. This operation requires interrupting spraying so that the active nozzles on each nozzle holder can be modified. Nozzle holders comprising multiple nozzles that can be active simultaneously, having an identical flow rate, or not, are thus known. These nozzle holders are generally automatically controllable by means of an actuator, most often pneumatic, making it possible to select the active nozzle(s) by means of a device for selecting the active nozzles.

Document FR3143268A1 describes an example of a multiple nozzle holder, mountable on a spray boom of an agricultural sprayer, that makes the use of multiple different nozzles possible, making the spraying of different plant protection products possible, in particular at different flow rates.

The invention aims to remedy all or part of the drawbacks of the state of the art by proposing a control system for this nozzle holder.

### SUMMARY

More precisely, the subject of the invention is a control device for controlling at least one nozzle holder of an agricultural sprayer, the device comprising:
an electric motor, housed in a housing of the control device, the electric motor driving a transmission element in rotation about a first reference axis, configured to transmit the rotational movement to an actuator of the nozzle holder;
at least one power cable, configured to supply electrical energy to the electric motor via an electronic board of the control device, the electronic board being housed in the housing;
an orientation sensor connected to the electronic board, the orientation sensor being configured to determine an angular orientation of the transmission element of the electric motor;

The control device is configured to control the rotation of the actuator of the nozzle holder by means of at least one predetermined command so as to activate at least one given spray nozzle of the nozzle holder, each predetermined command being associated with a respective angular orientation of the transmission element of the electric motor.

Using this combination of features, precise and automatic control of the nozzle holder is achieved, ultimately making an automatic and controlled selection of the spray nozzles possible, such as spraying a first given plant protection product using one of the nozzles of the nozzle holder and a second given plant protection product using another of the nozzles of the nozzle holder. In the same way, this control device can make it possible to modify the flow rate of a sprayer, such as by modifying the active nozzle. Thus, an operator of a sprayer, carried by an agricultural machine, for example, can modify the command of a nozzle holder without getting down from said agricultural machine. This results in a significant time saving and an improvement in operator safety. This device equipped with this sensor makes it possible to obtain feedback on the active nozzle, making it possible to signal any malfunction, such as a mechanical blockage of the device or of the nozzle-holder mechanism.

Advantageously, the transmission element is configured to transmit the rotational movement to the actuator about a second reference axis, parallel to the first reference axis. This configuration makes it possible to radially offset the axis of the transmission element, in particular of the pinion, and of the electric motor, relative to the axis of the actuator, making it possible to position the device above the nozzle holder relative to the ground, for example.

Advantageously, the housing is comprised of a first stage and a second stage, stacked, the transmission element and the orientation sensor being housed in the first stage of the housing and the electric motor and the electronic board being housed in the second stage, with the second stage extending above the first stage. In this configuration, the electronic and electrical components are separated from the mechanical components. In addition, this configuration also contributes to being able to position the device above the nozzle holder relative to the ground.

Advantageously, the housing is comprised of a protruding groove around the actuator, on the first stage, at the connection between the housing and the actuator, said groove having a shape, such as an axial baffle, that is complementary to that of the actuator.

Advantageously, the control device is comprised of a reducer housed in the housing, the reducer being arranged between the transmission element of the electric motor and the actuator of the nozzle holder. In addition, the reducer can extend between the first stage and the second stage.

Advantageously, the power cable extends through a wall of the housing, so that a first part of the power cable extends inside the housing of the control device and a second part of the power cable extends outside the housing of the control device, with the two parts of the cable being delimited by a sealing member of the housing.

Advantageously, the sealing member is formed by a resin filling a baffle arranged at the housing inlet, with the first part of the power cable extending through the baffle. The sealing is substantially improved in this configuration, making it possible to protect the mechanical and electronic components of the device.

Advantageously, the control device is comprised of two power cables, each power cable being configured to connect the electronic board of the control device to an adjacent control device. The adjacent devices can be connected in series in this configuration, so that a single energy source can supply multiple devices, or so that the same command can be addressed to these multiple devices.

Advantageously, the electric motor is a stepper electric motor.

Advantageously, the orientation sensor is arranged facing a toothed wheel meshing with the transmission element, a target being arranged on the toothed wheel, said target being configured to be detected by the orientation sensor. In this configuration, the sensor reading the angular orientation of the toothed wheel target, such as a magnet, makes it possible to precisely determine a corresponding angular orientation of the pinion.

Advantageously, the control device is comprised of fastening devices, configured to clip said control device onto a spray boom and to secure it to the nozzle holder.

According to another aspect of the invention, it relates to a control system comprising multiple control devices as described above, each control device being connected to at least one other control device by means of their power cables joining to form nodes, the electronic boards of the control devices and the nodes being configured to form a communication network, preferably a CAN communication network of the system, the control system being configured to control multiple nozzle holders of an agricultural sprayer.

According to another aspect of the invention, it relates to an agricultural sprayer comprising a control system as described above and a spray boom, wherein the control devices are mounted on the spray boom, vertically above said spray boom.

### BRIEF DESCRIPTION OF THE DRAWINGS

The invention will be better understood on reading the description that follows, given solely by way of example and referring to the accompanying drawings, given by way of non-limiting examples, wherein identical references are given to similar objects and wherein:

FIG. 1 is a schematic representation in isometric perspective of a nozzle holder and its drive device according to a first embodiment of the invention;

FIG. 2 is a partial schematic sectional view of the drive device of FIG. 1;

FIG. 3 is a partial schematic representation in isometric perspective of the drive device of FIG. 1, in a position with a part of the housing removed;

FIG. 4 is a partial schematic top view of the drive device of FIG. 1, in a position with another part of the housing removed;

FIG. 5 is a partial schematic front view of the drive device of FIG. 1;

FIG. 6 is a schematic front view of a system comprising multiple control devices according to another aspect of the invention.

It should be noted that the figures set out the invention in detail to make it possible for the invention to be implemented; although non-limiting, said figures serve in particular to better define the invention, as applicable.

### DETAILED DESCRIPTION

The invention relates to an agricultural spraying device in particular, such as a sprayer carried by an agricultural machine. This sprayer is comprised of a spray boom in particular, provided with multiple nozzle holders extending over its entire length. Such nozzle holders are described in document FR3143268A1 in particular.

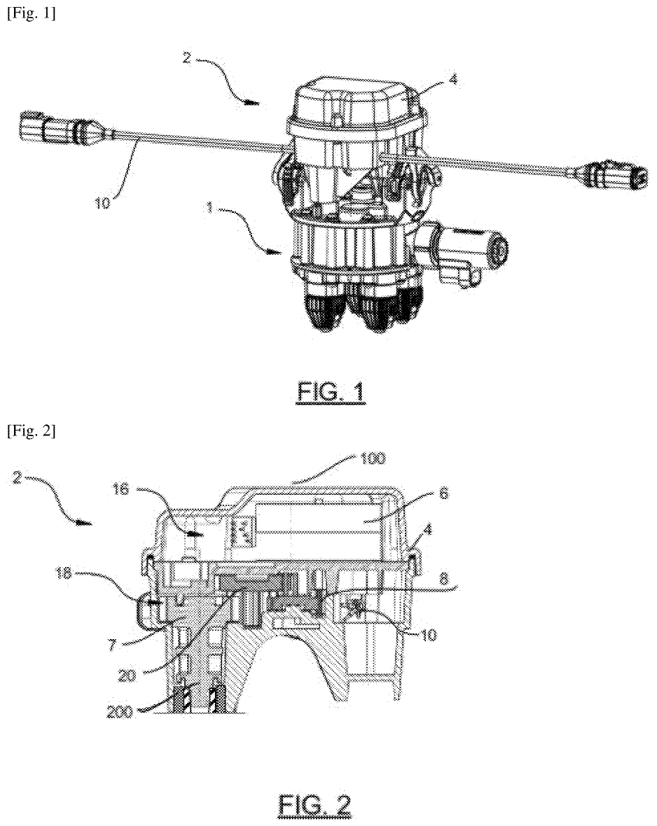

FIG. 1 illustrates a nozzle holder 1 as described above, according to a first aspect of the invention. A control device 2 associated with said nozzle holder 1 extends above the nozzle holder 1 relative to the ground, i.e. in a direction opposite the spray direction of the nozzles of the nozzle holder 1. The illustrated control device 2 is configured to control the nozzle holder 1. The term “control” means the possibility of an operator selecting the active nozzle(s) of the nozzle holder remotely, without direct manual intervention on the nozzle holder 1.

The control device 2 is comprised of a housing 4 secured to the body of the nozzle holder 1, preferably mounted removably. When the nozzle holder 1 and the control device 2 are mounted on a spray boom, the housing 4 of the control device 2 extends above said boom. The housing 4 defines an internal volume and is configured to receive electronic and mechanical components of the control device 2. The housing 4 is clipped onto the body of the nozzle holder 1, and is configured to be detached tool-free from the nozzle holder 1.

As visible in FIG. 2 in particular, the control device 2 is comprised of an electric motor in particular, housed in the housing 4. The electric motor 6 drives a transmission element 8 in rotation about a first reference axis 100. In the described embodiment, the transmission element 8 is a pinion. Alternatively, the transmission element 8 can be formed by a set of pulleys and at least one belt, for example, or even by a chain system.

Here, the electric motor 6 is a standard stepper motor, for example. Preferably, the electric motor 6 is comprised of a one-piece cage that has a surface treatment such as zinc plating and is devoid of steel bearings, which are particularly sensitive to the naturally humid environment of the nozzle holder 1.

The pinion 8 is configured to transmit the rotational movement to an actuator 7 of the control device 2, which transmits it to a gear train of the nozzle holder 1. Here, the electric motor 6 drives the pinion 8 in rotation about the first reference axis 100 and the pinion 8 is configured to transmit the rotational movement to the actuator 7 about a second reference axis 200, parallel to the first reference axis 100. When the nozzle holder 1 is installed on a spray boom, the reference axes 100, 200 are orthogonal to the longitudinal direction of said boom in particular.

The control device 2 is also comprised of at least one power cable 10. In the embodiment described in FIGS. 1 to 5, the control device 2 is comprised of two power cables 10. Thus, the power cable 10 is configured to supply electrical energy to the electric motor 6 and transmit a control signal. The power cable 10 supplies the electric motor 6 via an electronic board 12, also housed in the housing 4. The electronic board 12 is configured to transmit at least one predetermined instruction to the electric motor 6 and to the pinion 8.

The control device 2 is also comprised of an orientation sensor 14 connected to the electronic board 12. The orientation sensor 14 is configured to determine an angular orientation of the pinion 8.

Using the control device 2, it is then possible to associate each instruction or predetermined command with a respective angular orientation of the pinion 8, i.e. with a respective angular orientation of the actuator 7 of the control device 2, which transmits it to a gear train of the nozzle holder 1, so as to activate one or more given spray nozzles of the nozzle holder. Precise and automatic control of the nozzle holder 1 is achieved by using this combination of features, ultimately making automatic selection of the spray nozzles possible, to spray with a different dosage, for example, or even to spray a first given plant protection product using one of the nozzles of the nozzle holder 1 and a second given plant protection product using another of the nozzles of the nozzle holder 1. In the same way, this control device 2 can make it possible to modify the flow rate of a sprayer, by modifying the active nozzle, for example. Thus, an operator of a sprayer, carried by an agricultural machine, for example, can modify the command of a nozzle holder 1 without getting down from said agricultural machine, or change the active nozzle depending on the speed of the agricultural machine. This results in significant time saving and an improvement in operator safety. This control device 2 equipped with this orientation sensor 14 makes it possible to obtain feedback on the active nozzle, making it possible to signal any malfunction, such as a mechanical blockage of the device or of the nozzle-holder mechanism, and thus prohibit spraying if necessary.

As illustrated particularly in FIG. 2, the housing 4 is comprised of two stages 16,18, in particular a first stage 18 and a second stage 16, extending above the first stage 18. In this configuration, the first stage 18 houses the pinion 8, the actuator 7 of the control device 2 and the power cables 10 in particular. The second stage 16 houses the electric motor 6, the orientation sensor 14 and the electronic board 12. Preferably, the two stages 16, 18 are separated by an intermediate plate, which in this embodiment can receive the electronic board 12 as well as guiding elements of the pinion 8. In this configuration, the electronic and electrical components are separated from the mechanical components. In addition, this configuration also contributes to positioning the device above the nozzle holder 1 relative to the ground. When the housing 4 is comprised of two stages, 16,18 the two stages 16, 18 can be formed from two distinct parts made integral.

Advantageously, the housing 4 is comprised of a protruding groove around the actuator 7, at the level of the first stage 18 and at the connection between the housing 4 and the actuator 7. This groove has a shape, such as an axial baffle, that is complementary to that of the actuator 7, as is particularly visible in FIG. 2. This complementarity of shape makes it possible to retain a lubricating element, such as grease, making it possible to achieve additional sealing between the control device 2 and the actuator 7.

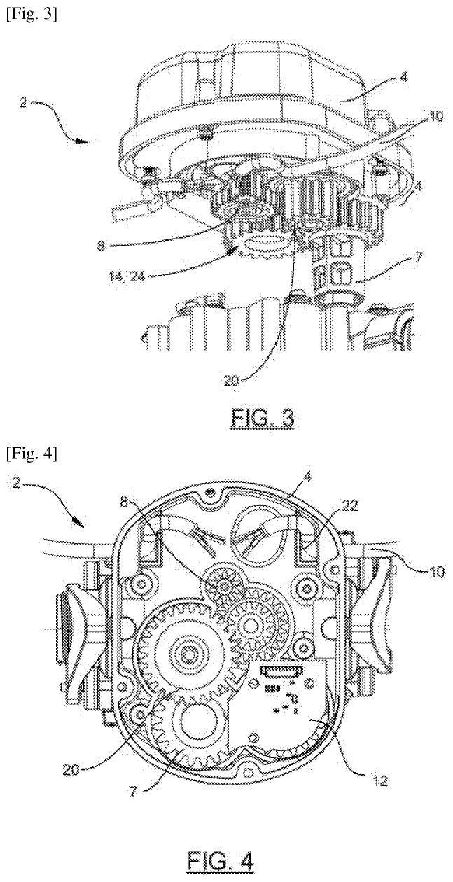

Advantageously, the control device 2 can be comprised of a reducer 20, as illustrated in FIG. 3 and in FIG. 4, where a part of the housing 4 corresponding to the respective first stage 18 or second stage 16, is not shown. Advantageously, the reducer 20 can be arranged on two vertical levels, each toothed element of the reducer 20 then comprising a different number of teeth at each end. In the case where the transmission element 8 is formed by a set of pulleys and a belt, the reducer can also be formed by a set of pulleys and belts.

The power cable 10 extends through a wall of the housing 4 so that a first part of the power cable extends inside the housing 4 and a second part of the power cable 10 extends outside the housing 4, as illustrated in FIG. 4. The two parts of the cable 10 are delimited by a sealing member 22 of the housing 4. In the described embodiment, the sealing member is formed by a resin (not shown) arranged in a baffle 22 of the housing 4. Thus, the first part of the power cable 10 extends through the baffle 22. There is naturally one baffle 22 per power cable 10 here. Sealing is thus achieved in this configuration, making it possible to protect the mechanical and electronic components of the device.

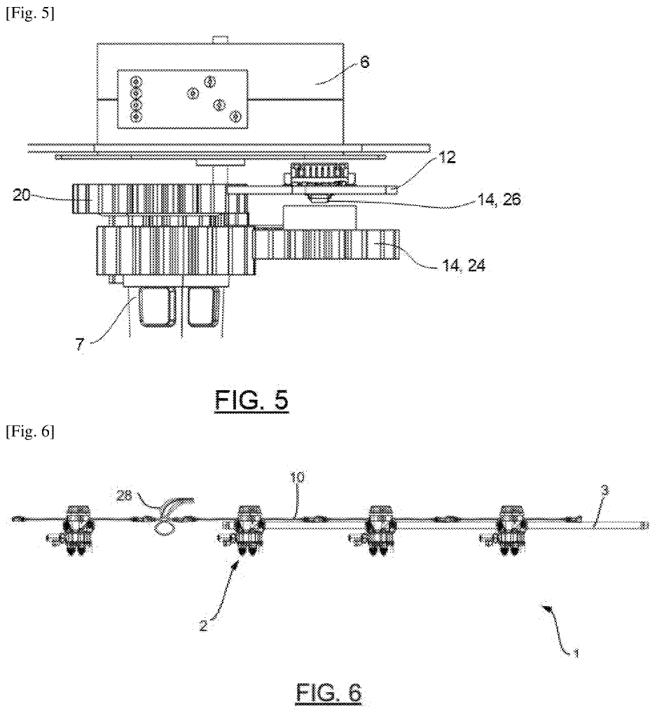

FIG. 5 illustrates one particular embodiment of the orientation sensor 14. The orientation sensor 14 is arranged under the electronic board 12, facing a toothed wheel 24 meshing with the pinion 8. The toothed wheel 24 is comprised of a target housed on the toothed wheel 24. The target is configured to be detected by the orientation sensor 14. In this configuration, reading the angular orientation of the toothed wheel 24 by detecting the target, such as a magnet, makes it possible to precisely determine a corresponding angular orientation of the pinion 8. Other embodiments of the sensor 14 are possible.

According to another aspect of the invention, it relates to a system comprising multiple control devices 2, as described above and as illustrated in FIG. 6. The multiple control devices and multiple nozzle holders 1 are mounted on a spray boom 3. Each control device 2 is connected to at least one other control device 2 by means of their power cables 10 joining to form nodes. Thus, electrical energy flows from adjacent device to adjacent device. This assembly is commonly referred to as being “in series”. The electronic boards 12 of the control devices 2 and the nodes are configured to form a communication network, in particular a CAN communication network of the system. The system thus formed is configured to control multiple nozzle holders 1 of an agricultural sprayer.

The same predetermined instruction can be addressed to each control device 2. This instruction can also be time-shifted, such as by the time necessary to activate a given spray nozzle, a time of the order of 0.3 seconds, to enable a substantial reduction in the instantaneous power required for the entire system. For example, a configuration in which the control devices 2 whose address is even can be controlled simultaneously and the control devices 2 whose address is odd can be controlled simultaneously with a time lag. The instantaneous power required is thus divided by two. A sequential configuration is also possible, depending on the site to be sprayed. Reducing the maximum instantaneous power required ensures that the overloading of components of the agricultural machine supplying the power, such as its alternator, is avoided.

In order to avoid power losses due to the assembly in series, the system can be comprised of connectors 28, configured to adjust the electrical energy circulating in the system. This assembly is commonly referred to as being in a “T”. Naturally, other assemblies are possible, depending on the dimensions of the agricultural sprayer. By way of example, a connector 28 can be arranged every six nozzle holders 1. This connector also makes it possible to reduce the cross-section of the power cables, since the current is readjusted on the system line.

Preferably, the assembly of the control device 2 on a nozzle holder 1 and the mounting on the spray boom 3 are carried out concomitantly. In other words, the control device 2 is comprised of fastening devices configured to clip it onto the spray boom 3 and making it possible to be secured to the body of the nozzle holder 1. These fastening devices enable quick, tool-free disassembly of the control device 2, and make it possible to obtain ideal centering of the actuator 7 of the control device 2 relative to the nozzle holder 1.

In addition, the control devices 2 are mounted on the spray boom 3 vertically above said boom, so that said spray boom extends above the body of the nozzle holder 1. This configuration makes it possible to substantially improve the space requirement between two adjacent nozzle holders, and also makes it possible to keep the mechanical and electronic elements as far as possible from the spray nozzles so as to protect them from humidity.

It will also be noted that the invention is not limited to the embodiments described above. It will indeed appear to the person skilled in the art that various modifications can be made to the embodiments described above, in light of the teaching that has just been disclosed to them.

In the detailed presentation of the invention made above, the terms used must not be interpreted as limiting the invention to the embodiment set out in the present description, but must be interpreted to include all equivalents foreseeable by the person skilled in the art by applying their general knowledge to implementing the teaching that has just been disclosed to them.

1. A control device for controlling at least one nozzle holder of an agricultural sprayer, the device comprising:
an electric motor, housed in a housing of the control device, the electric motor driving a transmission element in rotation about a first reference axis, configured to transmit the rotational movement to an actuator of the nozzle holder;
at least one power cable, configured to supply electrical energy to the electric motor via an electronic board of the control device, the electronic board being housed in the housing;
an orientation sensor connected to the electronic board, the orientation sensor being configured to determine an angular orientation of the transmission element of the electric motor;
the device being configured to control the rotation of the actuator of the nozzle holder by means of at least one predetermined command so as to activate at least one given spray nozzle of the nozzle holder, each predetermined command being associated with a respective angular orientation of the transmission element of the electric motor.

2. The control device according to claim 1, wherein the transmission element is configured to transmit the rotational movement to the actuator about a second reference axis, parallel to the first reference axis.

3. The control device according to claim 2, wherein the housing comprises a first stage and a second stage, stacked, the transmission element and the orientation sensor being housed in the first stage of the housing and the electric motor and the electronic board being housed in the second stage, the second stage extending above the first stage.

4. The control device according to claim 3, wherein the housing comprises, at the first stage, at the junction between the housing and the actuator, a protruding groove around the actuator, said groove having a shape, such as an axial baffle, complementary to that of the actuator.

5. The control device according to claim 1, comprising a reducer housed in the housing, the reducer being arranged between the transmission element of the electric motor and the actuator of the nozzle holder.

6. The control device according to claim 1, wherein the power cable extends through a wall of the housing, so that a first part of the power cable extends inside the housing of the control device and a second part of the power cable extends outside the housing of the control device, the two parts of the cable being delimited by a sealing member of the housing.

7. The control device according to claim 6, wherein the sealing member is formed by a resin filling a baffle arranged at the inlet of the housing, the first part of the power cable extending through the baffle.

8. The control device according to claim 1, comprising two power cables, each power cable being configured to connect the electronic board of the control device to an adjacent control device.

9. The control device according to claim 1, wherein the electric motor is a stepper electric motor.

10. The control device according to claim 1, wherein the orientation sensor is arranged facing a toothed wheel meshing with the transmission element, a target being arranged on the toothed wheel, said target being configured to be detected by the orientation sensor.

11. The control device according to claim 1, wherein the control device is comprised of fastening devices, configured to clip said control device onto a spray boom and to secure the nozzle holder.

12. A control system comprising multiple control devices according to claim 1, each control device being connected to at least one other control device by means of their power cables joining to form nodes, the electronic boards of the control devices and the nodes being configured to form a communication network, preferably a CAN communication network of the system, the control system being configured to control multiple nozzle holders of an agricultural sprayer.

13. An agricultural sprayer comprising a control system according to the claim 12 and a spray boom, wherein the control devices are mounted on the spray boom, vertically above said spray boom.
